(19) United States
(12) Patent Application Publication
(10) Pub. No.: US 2002/0157534 A1
(43) Pub. Date: Oct. 31, 2002

(54) Connecting rod bore profile for bushingless piston assembly

(75) Inventors: Jason Howell Schneider, Waterloo, IA (US); Horst Baumann, Taylors, SC (US)

Correspondence Address: Joel S. Carter, Patent Department, DEERE & COMPANY, One John Deere Place, Moline, IL, 61265-8098, US

(73) Assignee: Deere & Company, a Delaware Corporation

(21) Appl. No.: 09/842,418

(22) Filed: Apr. 25, 2001

(51) Int. Cl. F16J 1/14

(52) U.S. Cl. 92/187

(57) ABSTRACT

A piston/connecting rod assembly is provided for an internal combustion engine. The piston has a piston pin bore which receives a piston pin. An end of a connecting rod has a connecting rod bore which receives the piston pin, and the wall of the connecting rod bore directly engages the piston pin, without a bushing therebetween. The connecting rod bore is symmetrical, and has a diameter which varies from a smaller uniform diameter central portion to a larger diameter portions at either end thereof. The connecting rod bore also has a profile which is symmetrical about a central plane which is perpendicular to a central axis of the connecting rod bore, and which is elliptical or quasi-elliptical on either side of a central uniform diameter portion.

### BACKGROUND OF THE INVENTION

The invention relates to a piston/connecting rod assembly for an internal combustion engine.

Typically, in a heavy duty diesel engine, a bushing is pressed into the piston end of the connecting rod. Such a bushing is normally machined as a perfect cylinder, and is formed of steel with a copper-lead lining. The bushing receives a piston pin which couples the connecting rod to the piston. Thus, the bushing transfers load and must conform to deflections of the piston pin. Such a bushing may also absorb debris which may enter into the interface between the bushing and the connecting rod. In engines which have a tapered connecting rod, the bushing is expensive and difficult to manufacture. Bushingless connecting rod/piston assemblies are commercially available, but without a proper profile, there can be edge loading between the connecting rod and the piston pin.

### SUMMARY OF THE INVENTION

Accordingly, an object of this invention is to provide a bushing-less piston/connecting rod assembly with reduced edge loading between the connecting rod and the piston pin.

A further object of the invention is to provide a bore profile for the piston end of a connecting rod in a bushingless piston/connecting rod assembly.

These and other objects are achieved by the present invention, wherein a piston/connecting rod assembly is provided for an internal combustion engine. The piston/connecting rod assembly includes a piston which has a piston pin bore extending therethrough. A piston pin extends through and is received by the piston pin bore. An end of a connecting rod has a bore which receives the piston pin, and the wall of the connecting rod bore directly engages the piston pin, without a bushing therebetween. The connecting rod bore is symmetrical about a central plane, and has a diameter which varies from a smaller diameter central portion to larger diameter portions at either end thereof. The connecting rod bore also has a profile which is symmetrical about a central plane which is perpendicular to a central axis of the connecting rod bore, and which is generally elliptical on either side of a central uniform diameter portion.

### BRIEF DESCRIPTION OF THE DRAWINGS

FIG. 1 is a sectional view of a piston/connecting rod assembly according to the present invention;

FIG. 2 is a side elevation view of a portion of the connecting rod of FIG. 1;

FIG. 3 is a view taken along lines 3-3 of FIG. 2.

### DESCRIPTION OF THE PREFERRED EMBODIMENT

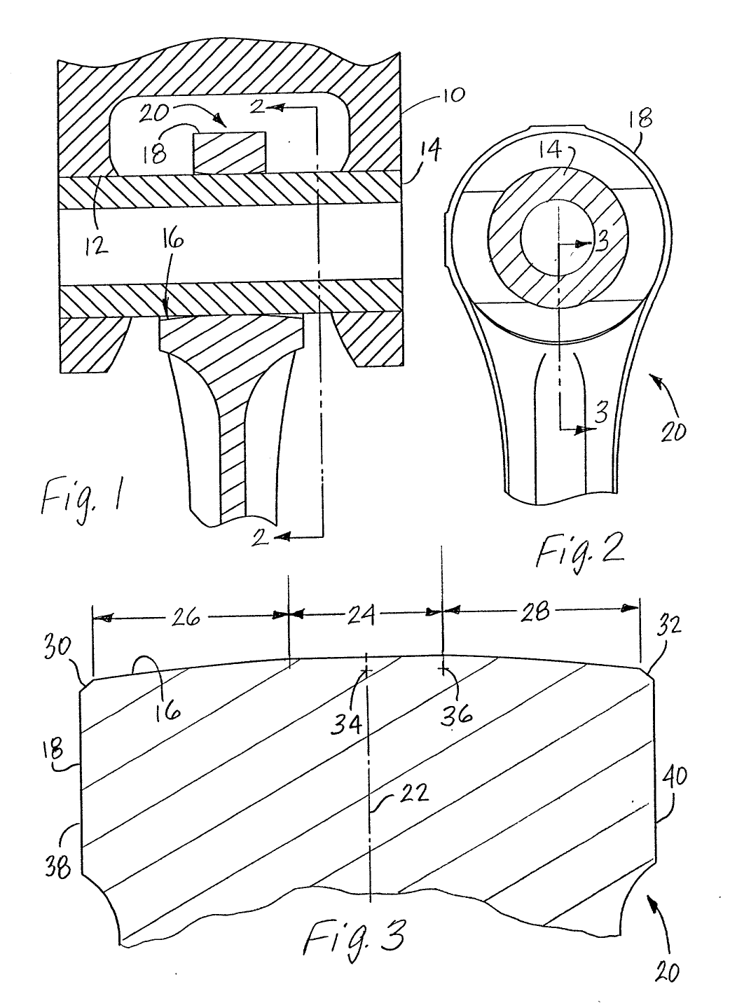

Referring to FIGS. 1 and 2, a piston 10, such as for an internal combustion engine (not shown) includes a piston pin bore 12 which receives a piston pin 14. The piston pin 14 is received by a bore 16 in the piston end 18 of a connecting rod 20. According to the present invention, there is no bushing interposed between the piston pin 14 and the wall of bore 16, and the wall of bore 16 directly engages the outer surface of the pin 14. The bore 16 is symmetrical about a central plane, but as best seen in FIG. 3, has a diameter which varies from a smaller diameter central portion to larger diameter portions at either end thereof.

As best seen in FIG. 3, the surface of bore 16 is symmetrical about a central plane 22 which is perpendicular to a central axis of the connecting rod bore 16. The bore 16 has a central portion 24 which has a uniform diameter so that forces transmitted between the rod 20 and the pin 14 are spread out rather than concentrated. The central portion 24 preferably receives the pin 14 with a slip fit.

The bore 16 is preferably symmetrical about the central plane 22, and has a central portion 24, with outer portions 26 and 28 arranged on either side thereof, and chamfers 30 and 32 at the outer ends thereof.

Portions 26 and 28 preferably have a curved profile in order to spread out loads across the entire surface of the profile and avoid concentrated loads at the outer ends thereof. One type of appropriate curved profile is an elliptical or an approximately or quasi-elliptical profile, although other non-elliptical curved profiles would also suffice. An appropriate profile can be determined by known 3D finite element analysis techniques.

If an elliptical or quasi-elliptical profile is used, then viewing FIG. 3, each profile corresponds to an ellipse or a quasi-ellipse which has a center 34 or 36. The centers 34, 36 are spaced apart on either side of the central plane 22. The distance from the central plane 22 to each center 34, 36 may vary, for example, from approximately a quarter to a third of the distance from the central plane 22 to the corresponding side wall 38, 40 of the rod end 18. Also viewing FIG. 3, each ellipse or quasi-ellipse preferably has a major axis which is perpendicular with respect to central plane 22 and a minor axis which is parallel to central plane 22. Preferably, the surfaces of portions 26 and 28 will depart from surfaces corresponding to a perfect ellipse by not more than +/−0.0035 millimeters. Preferably, a ratio of the length of the major axis to the length of the minor axis is approximately 300.

The outer surface of the piston pin 14 may be coated with Mn-Phosphate, or any other coating or flash capable of bearing the load and temperature, to add lubricity and to allow some degree of break-in wear between the connecting rod 20 and the pin 14. Alternatively, the surface of bore 16 alone or both surfaces could be similarly coated.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

1. A piston/connecting rod assembly for an internal combustion engine, comprising:
a piston having a piston pin bore extending therethrough;
a piston pin extending through and received by the piston pin bore; and
a connecting rod having a connecting rod bore which receives the piston pin, a wall of the connecting rod bore directly engaging the piston pin, the connecting rod bore having a diameter which varies from a smaller diameter central portion to larger diameter portions at either end thereof.

2. The piston/connecting rod assembly of claim 1, wherein:
a portion of the wall of the connecting rod bore has a curved profile which distributes loads across a surface of the profile.

3. The piston/connecting rod assembly of claim 1, wherein:
a portion of the wall of the connecting rod bore has a quasi-elliptical profile.

4. The piston/connecting rod assembly of claim 1, wherein:
a portion of the wall of the connecting rod bore has an elliptical profile.

5. The piston/connecting rod assembly of claim 1, wherein:
a portion of the wall of the connecting rod bore has an elliptical profile corresponding to an ellipse having a center which is spaced apart from a central plane which is perpendicular to a central axis of the connecting rod bore;

6. The piston/connecting rod assembly of claim 1, wherein:
the connecting rod bore has a profile which is symmetrical about a central plane which is perpendicular to a central axis of the connecting rod bore.

7. The piston/connecting rod assembly of claim 6, wherein:
the wall of connecting rod bore has an elliptical profile.

8. The piston/connecting rod assembly of claim 6, wherein:
the wall of connecting rod bore has an elliptical profile corresponding to an ellipse having a center which is spaced apart from a central plane which is perpendicular to a central axis of the connecting rod bore.

9. The piston/connecting rod assembly of claim 6, wherein:
the wall of connecting rod bore has a pair of elliptical profiles, each profile corresponding to an ellipse having a center which is spaced apart from a central plane which is perpendicular to a central axis of the connecting rod bore.

10. The piston/connecting rod assembly of claim 9, wherein:
a distance from the central plane to each center is a quarter to a third of a distance from the central plane to a corresponding side wall of the connecting rod.

11. The piston/connecting rod assembly of claim 9, wherein:
each ellipse has a major axis which is perpendicular with respect to center line and a minor axis which is parallel to center line.

12. The piston/connecting rod assembly of claim 11, wherein:
a ratio of a length of the major axis to a length of the minor axis is approximately 300.
